(19) United States
(12) Patent Application Publication
(10) Pub. No.: US 2008/0095211 A1
(43) Pub. Date: Apr. 24, 2008

(54) Apparatus For Testing Reliability Of Semi-Conductor Sample

(76) Inventors: Jong Jun You, Daejeon (KR); Young Goo Kim, Cheongju (KR); Tae Hong Kim, Daejeon (KR)

Correspondence Address: RABIN & Berdo, PC, 1101 14TH STREET, NW, SUITE 500, WASHINGTON, DC, 20005, US

(21) Appl. No.: 11/577,212

(22) PCT Filed: Dec. 14, 2005
(86) PCT No.: PCT/KR05/04299

§ 371 Date: Apr. 13, 2007

(30) Foreign Application Priority Data
Dec. 16, 2004 (KR) 10-2004-0107036

(51) Int. Cl. G01N 25/00

(52) U.S. Cl. 374/45

(57) ABSTRACT

Provided is a apparatus for testing reliability of a semiconductor sample including: a sample mounting part for mounting the semiconductor sample on an upper center part thereof, and mounting components having an evaluation circuit board at an upper peripheral part thereof; a heating block formed to have a tip shape and mounted on a lower part of the semiconductor sample to maintain a test temperature; a cooling block separated from the heating block and surrounding the heating block to cool the temperature of the components; and a fixing block for raising and lowering the semiconductor sample.

### BACKGROUND ART

1. Field of the Invention

The present invention relates to an apparatus for testing reliability of a semi-conductor sample and, more particularly, to a reliability test apparatus for reliably performing an accelerated life test of a semiconductor device.

2. Description of Related Art

Together with development of mobile communication and semiconductor technologies, semiconductor devices, in particular, high frequency devices and components are being miniaturized and integrated. In addition, in order to increase competition against goods of other companies and foreign countries in global competition and reduce a great quantity of time, equipment and cost consumed for development and production test, necessity of reliability is being continuously increased. The accelerated life reliability testing is performed to develop a high reliability of new semiconductor device, which is essential to estimate a lifetime of new RF semi-conductor devices and components under severe conditions.

In particular, it is necessary for the test to estimate the lifetime of semiconductor devices such as a power amplifier module (PAM), a surface acoustic wave (SAW), and compound semiconductor device and component of microwave band, in which a package used in a terminal is formed as a surface-mounted device (SMD).

Such a conventional semiconductor test apparatus is disclosed in Korean Patent Registration No. 1990-3611, entitled Apparatus for evaluating semiconductor sample under high temperature environment and its operation.

The apparatus includes a heating block and a cooling block thermally isolated from each other by interposing an air space therebetween. Since the semiconductor sample is directly attached to the heating block, heat generated from the heating block can be directly conducted to the semiconductor sample through a negligible quantity of insulating resistance. Meanwhile, a micro strip, matching circuit boards, and related connectors are attached to the cooling block to prevent their temperature from rising. The cooling block has an air space therein to provide spatial isolation so that the heat from the heating block is almost not conducted to the components. Eventually, preferably, the micro strip matching circuits and connectors disposed in a setting apparatus are protected from the temperature increase, and a ground means is provided to ground the semiconductor sample and related matching circuits.

However, the conventional reliability test apparatus could test only the semi-conductor sample including the matching circuit, a temperature of which is increased up to 65° C., and not including external evaluation circuits. In addition, since the semi-conductor sample is directly attached to the heating block to have a negligible small insulating resistance and control a temperature using a thermocouple installed in the heater itself, it is impossible to measure a real temperature of the semiconductor sample.

In addition, in order to test a plurality of same semiconductor samples, troublesome operations should be repeated.

### SUMMARY OF THE INVENTION

The present invention is directed to a novel type of integrated reliability test apparatus including an evaluation circuit and related matching components.

The present invention is also directed to a reliability test apparatus capable of precisely adjusting a temperature of a semiconductor sample and separately adjusting a temperature of an external evaluation circuit from the temperature of the sample.

The present invention is also directed to a newly improved semiconductor test apparatus capable of estimating a lifetime of a semiconductor device through a re-liability test using a plurality of samples.

In an exemplary embodiment of the present invention, an apparatus for testing re-liability of a semiconductor sample includes: a sample mounting part for mounting the semiconductor sample on an upper center part thereof, and mounting components having an evaluation circuit board at an upper peripheral part thereof; a heating block formed to have a tip shape and mounted on a lower part of the semiconductor sample to maintain a test temperature; a cooling block separated from the heating block and surrounding the heating block to cool the temperature of the components; and a fixing block for raising and lowering the semiconductor sample.

“Semiconductor sample” is referred to as a various kinds of semiconductor devices known in the art, for example, an RF semiconductor device and components.

Preferably, the heating block and the cooling block are separated from each other by a back lite formed of thermostable plastic to maintain a thermally isolated state. As a result, when the semiconductor sample is maintained at a high temperature of about 250° C., an evaluation circuit and a matching circuit are maintained at a temperature of less than 40°.

Meanwhile, the heating block may include a cartridge-type heating tip, and a resistance temperature detector (RTD) sensor installed at a lower part of the semi-conductor sample.

The sample mounting part may further include a matching circuit board; in this case, when the matching circuit board and the evaluation circuit board are connected to each other using a bonding wire such as gold, it is advantageous to transmit an RF signal and a bias signal and block common potential and thermal conduction.

Preferably, RF connectors are connected to both upper ends of the evaluation circuit board.

Meanwhile, contact between the semiconductor sample and the matching circuit can be finely and simply adjusted using the fixing block.

### BRIEF DESCRIPTION OF THE DRAWINGS

The above and other features of the present invention will be described in reference to certain exemplary embodiments thereof with reference to the attached drawings in which:

FIG. 1 is a perspective view of an apparatus for testing reliability of a semi-conductor sample in accordance with an embodiment of the present invention;

FIGS. 2 and 3 are a partial perspective view and a plan view of the apparatus for testing reliability of the semiconductor sample of FIG. 1;

FIGS. 4 and 5 are cross-sectional views taken along lines A-A and B-B of the test apparatus of FIG. 3; and

FIG. 6 is a schematic perspective view of a fixing block of the semiconductor sample of FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

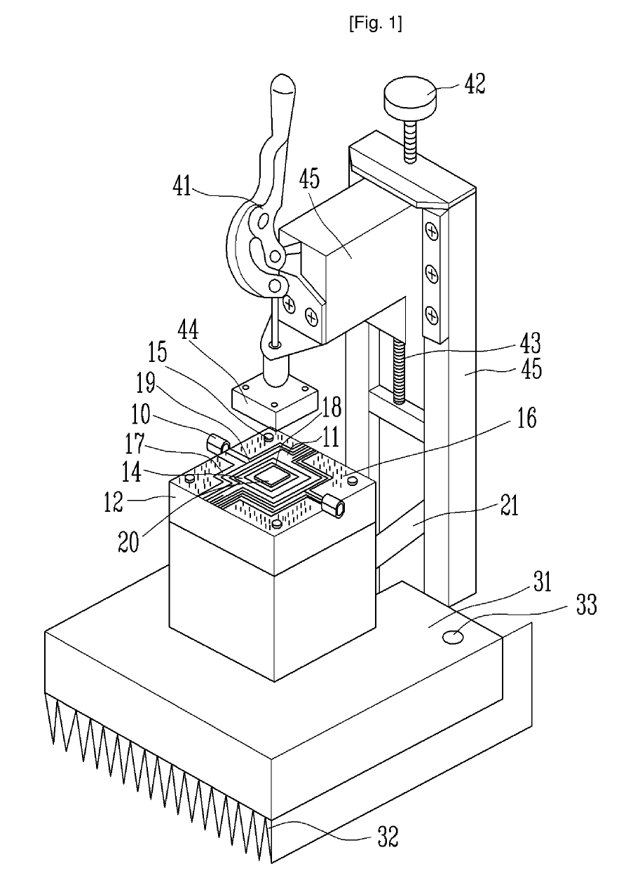

FIG. 1 is a perspective view of an apparatus for testing reliability of a semi-conductor sample in accordance with an embodiment of the present invention.

The test apparatus 1 includes a sample mounting part 12, a heating block having elements 11, 21 and 26, a cooling block 31, and a fixing block having elements 41, 42, 43, 44, 45, 46 and 47. The sample mounting part 12 is provided with an upper center part for mounting a semiconductor sample, and an upper peripheral part for mounting an evaluation circuit board 16, matching circuit related components 19, a bonding wire 18, an RTD sensor 11, a fixing tip 14 and so on.

In the test apparatus, in order to maintain the temperature of the evaluation circuit board 16 and the matching circuit related components 19 under 40° C. while the test temperature is maintained at about 250° C. for a long time, the heating block having elements 11, 21 and 26 and the cooling block 31 are separated from each other. The heating block having elements 11, 21 and 26 is formed to have a tip shape, thereby applying heat to a lower part of the semiconductor sample 20, and the cooling block 31 is formed to surround the heating block, which will be described later.

The fixing block having elements 41, 42, 43, 44, 45, 46 and 47 is in contact with an upper surface of the semiconductor sample 20 to raise and lower the semiconductor sample 20 along a z-axis. In addition, contact between the semiconductor sample 20 and the matching circuit 19 can be finely and simply adjusted using the fixing blocks, and therefore, the semiconductor sample 20 can be easily exchanged.

The reliability test apparatus includes the heating block, the cooling block, and the fixing block, which are thermally isolated from one another. The heating block has an RTD sensor formed of a ceramic material disposed between the heating block and the semiconductor sample to precisely control and maintain the temperature, which is to be measured simultaneously with the heat conduction.

Meanwhile, the evaluation circuit, the matching components, and the related connectors are located on the cooling block, which are thermally isolated from the heating block, so that heat from the heating block is almost not conducted to them. Eventually, the external evaluation circuit, the matching components, and the related connectors disposed in the test apparatus are protected from the temperature increase.

Hereinafter, specific constitution and operation of the test apparatus for a semi-conductor sample of FIG. 1 will be described in conjunction with the accompanying drawings.

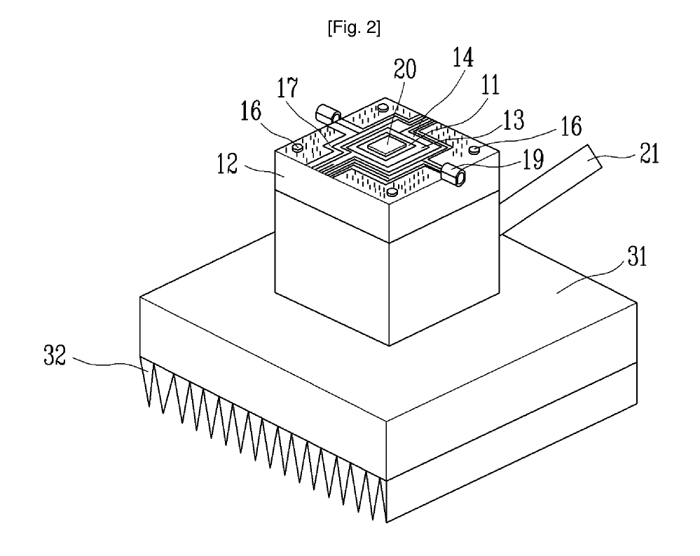

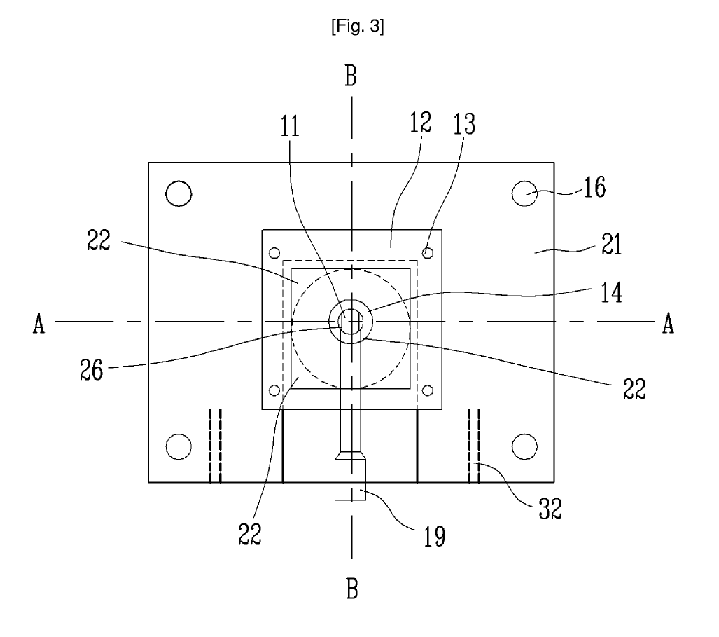

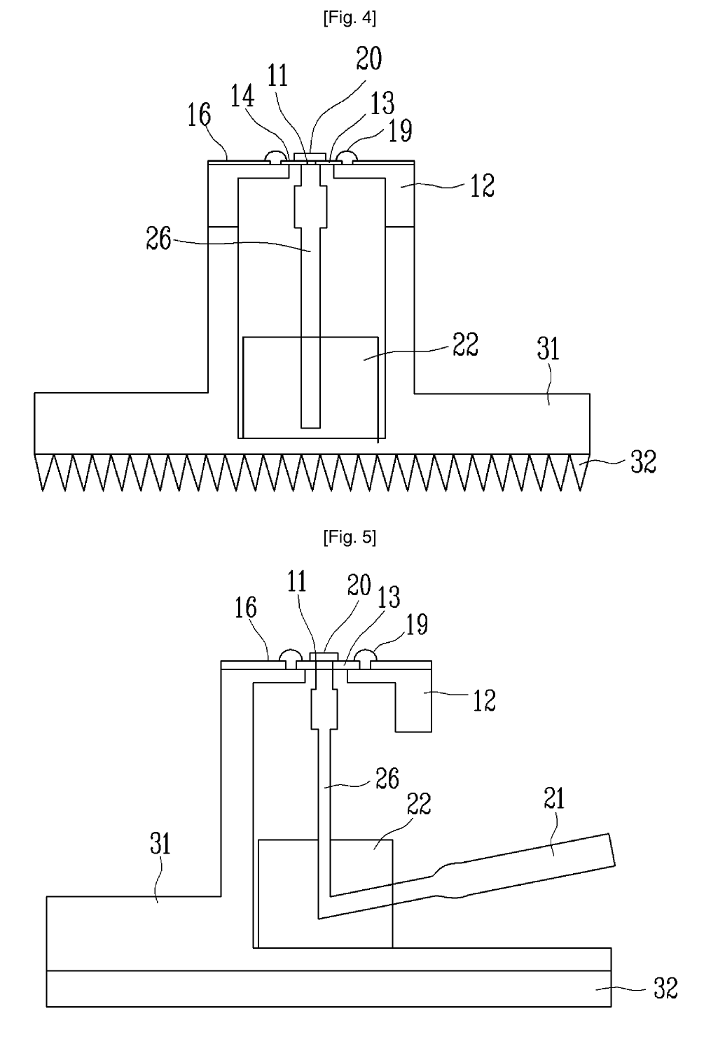

FIGS. 2 and 3 are a partial perspective view and a plan view of the apparatus for testing reliability of the semiconductor sample of FIG. 1, and FIGS. 4 and 5 are cross-sectional views taken along lines A-A and B-B of the test apparatus of FIG. 3.

Referring to FIGS. 2 to 5, the heating block includes a cartridge-type heating tip 26 disposed in the test apparatus to concentrate heat to the semiconductor sample 20, a support member 21, and a resistance temperature detector (RTD) sensor 11. The heating tip 26 is preferably formed of copper or brass. The heating tip 26 is a cartridge-type heater. The heat from the heating tip 26 is controlled by a computer using a thermostat employing the RTD sensor 11, and the RTD sensor 11 has a detection part having a width of 1.5 mm and a length of 2.5 mm and a use temperature range of −100˜500° C.

Meanwhile, the heating block is spaced apart from the cooling block 31 by a backlite 22 formed of an easily treatable and thermostable plastic and securely fixed by screws 23 in order to fix the heating tip 26. This is to reduce heat conduction to the cooling block 31 from the heating block. Meanwhile, the support member 21 is fixed to the backlite 22 by a screw (not shown).

The sample mounting part 12 is connected to an upper part of the cooling block 31. The sample mounting part 12 may be formed of a material that heat can be easily conducted, e.g., a metal. The evaluation circuit board 16 and the connector 19 are connected to an upper part of the sample mounting part 12 and spaced apart from the heating tip 26 by the air space. A heat sink 32 is closely attached to a lower surface of the cooling block 31 using a screw 33 and a radiating compound to maximize the cooling effect.

The matching circuit board 13 mounted on the sample mounting part 12 is formed of a ceramic, alumina or Teflon substrate. The matching circuit board 13 formed corresponding to the size of the RTD sensor 11 is connected to a lower surface of the semiconductor sample 20 to be fixed by the fixing tip 14. The evaluation circuit board 16 and the matching circuit related components 17 are fixed to the sample mounting part 12 by screws 15. The matching circuit board 13 and the evaluation circuit board 16 are connected to each other by the bonding wire 18 so that the same ground potential can be provided to all of the blocks. The RF connector 19 may be connected to both ends of the evaluation circuit board 16.

Meanwhile, the ground potential for high frequency power can be obtained by connecting an integral body formed of aluminum and a substrate using the bonding wire. As a result, it is possible to reliably estimate the lifetime of the RF semiconductor device and components by heating the heating block for a test period, without damage of the matching circuit related components 17 and the related connector 19.

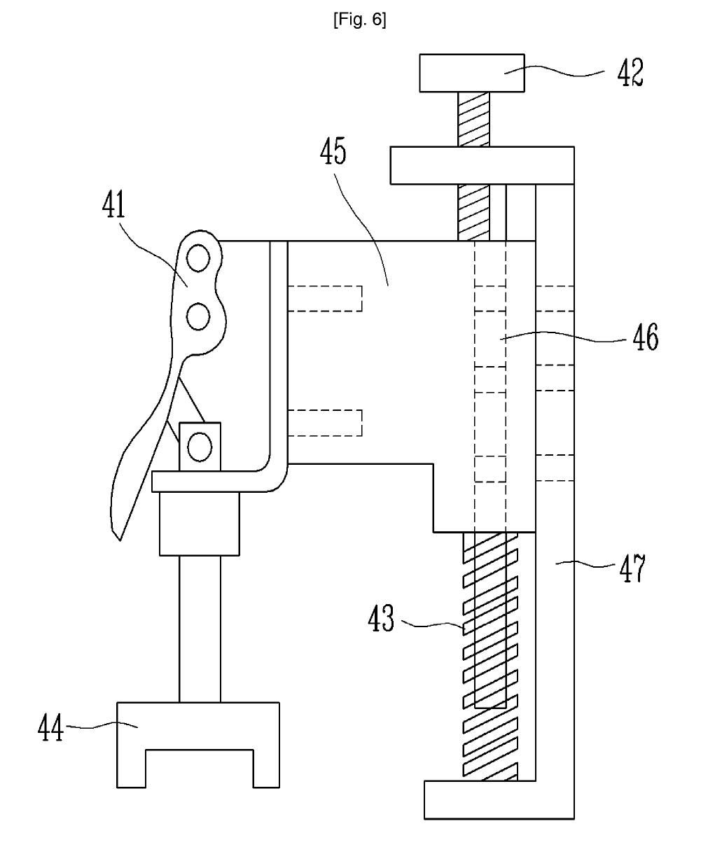

FIG. 6 is a schematic perspective view of a fixing block of the semiconductor sample of FIG. 1.

The fixing block having elements 41, 42, 43, 44, 45, 46 and 47 is fixed to the cooling block 31 by fixing screws (not shown), and uses a toggle clamp 41 to raise and lower the semiconductor sample 20 to press the matching circuit board 13. In addition, a vertical adjustment screw 42 adjusts and fixes the semiconductor sample along a z-axis using a compression coil spring 43 to enable to test various semiconductor samples 20 having different heights.

A pressure pusher 44 formed corresponding to the size of the semiconductor sample 20 and the matching circuit is in contact with an upper surface of the semiconductor sample 20 to press the sample, thereby protecting the bonding wire and blocking the heat. A z-axis slide block 45 and a z-axis slide guide 46 are fixed to a z-axis slide base 47 which is a central axis of the apparatus, to be adjusted along a z-axis.

As described above, the heat generated from the heating block is effectively conducted to the sample and monitored, but not conducted to the cooling block and effectively radiated. For example, as a result of test measurement, when a chip is maintained at a temperature of 250° C., the evaluation circuit board and the matching circuit related component are maintained at a temperature of less than 40° C.

As can be seen from the foregoing, the test apparatus of the present invention can obtain reliability of the test by precisely controlling the test temperature of the sample using the RTD sensor and thermally isolating the evaluation circuit and the driving components. In addition, it is possible to simply modify the setting apparatus by forming the heating tip, the matching circuit, and the evaluation circuit according to various samples, and easily mount and test numerous samples in order to estimate a lifetime of the semiconductor device.

Meanwhile, it is possible to finely and simply adjust contact between the chip and the matching circuit.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

1. An apparatus for testing reliability of a semiconductor sample comprising:
a sample mounting part for mounting the semiconductor sample on an upper center part thereof, and mounting components having an evaluation circuit board at an upper peripheral part thereof;
a heating block formed to have a tip shape and mounted on a lower part of the semiconductor sample to maintain a test temperature;
a cooling block separated from the heating block and surrounding the heating block to cool the temperature of the components; and
a fixing block for raising and lowering the semiconductor sample.

2. The apparatus according to claim 1, wherein the heating block and the cooling block are separated from each other by a back lite formed of thermostable plastic.

3. The apparatus according to claim 1, wherein the heating block comprises a cartridge-type heating tip, and a resistance temperature detector (RTD) sensor installed at a lower part of the semiconductor sample.

4. The apparatus according to claim 1, wherein the semiconductor sample is a chip having an RF semiconductor device.

5. The apparatus according to claim 1, wherein the sample mounting part further comprises a matching circuit board.

6. The apparatus according to claim 5, wherein the matching circuit board and the evaluation circuit board are connected to each other using a bonding wire.

7. The apparatus according to claim 1, wherein a connector is connected to both upper ends of the evaluation circuit board.
